(19) United States
(12) Patent Application Publication
(10) Pub. No.: US 2014/0190955 A1
(43) Pub. Date: Jul. 10, 2014

(54) Electrical utility box enclosing power supply and thermoregulator for a coil heater

(71) Applicant: Paul Jeffery Barca, JR., Piscataway, NJ (US)

(72) Inventor: Paul Jeffery Barca, Jr., Piscataway, NJ (US)

(21) Appl. No.: 14/218,251

(22) Filed: Mar. 18, 2014

(51) Int. Cl. H05B 3/42

(52) U.S. Cl. CPC H05B 3/42
USPC 219/488; 361/642

(57) ABSTRACT

An electrical utility box that houses various electrical devices to heat a coil heater to heat titanium rod through the process of thermal conduction. The titanium rod is heated for the purpose of vaporizing concentrated essential oils of medical marijuana. The electrical utility box utilizes a closed-loop advanced proportional plus integral plus derivative controller for controlling the temperature.

Claiming benefit to the following non-provisional applications;
Advanced proportional plus integral plus derivative controller; U.S. Pat. No. 4,908,747. Issue date: Mar. 13, 1990. Application Ser. No. 07/170,509. Filing date: Jun. 1, 1988. Inventors: Lane; John D., Matasko; Theodore N., Joseph G., Scheilb; Thomas J.
Step down transformer power supply with short circuit protection; U.S. Pat. No. 5,561,576. Issue date: Oct. 1, 1996. Application Ser. No. 08/409,593. Filing date: Mar. 24, 1995. Inventors: Baldwin; John R.
High-power solid state relay employing photosensitive current augmenting means for faster turn on time; U.S. Pat. No. 4,902,901. Issue date: Feb. 20, 1990. Application number: EP19900303596. Filing date: Apr. 4, 1990. Inventors Pernyeszi; Joseph.
Spiral wound shunt type slow blow fuse; U.S. Pat. No. 4,560,971. Issue date: Dec. 4, 1985. Application Ser. No. 06/648,175. Filing date: Sep. 10, 1984. Inventors: Oh; Seibang.
Universal adapter kit for mini microphone; U.S. Pat. No. 5,805,985. Issue date: Sep. 8, 1998. Application Ser. No. 08/494,240. Filing date: Jun. 23, 1995. Inventors: Clegg; Wren A., Reisinger; William S.
Push Button Switch; U.S. Pat. No. 8,350,484. Issue date: Jan. 8, 2013. Application Ser. No. 13/066,722. Filing date: Apr. 22, 2011. Inventors: Staley; Oliver Conrad. Inventors: Reisinger; William S., Clegg; Wren A.

Electrical utility box enclosing power supply and thermoregulator for a coil heater.

Claiming benefit to the following provisional applications;
Variable Pitch Resistance Coil Heater; U.S. application Ser. No. 13/481,667. Filing date: May 25, 2012. Inventors: Long; Dennis P., Juliano; Ronaldo O.

### DESCRIPTION OF THE ART

Used for the process of heating and or vaporizing the essential oils of concentrated medical marijuana for the purpose of inhalation. Recent development of concentrated forms of marijuana has provided a product which is free from bi-products ordinarily found in plant material. The plant material may contain but not limited to lipids, waxes, carbohydrates, and chlorophyll.

Current administration of the medical benefits of the essential oils involves the process of heating a rod made of titanium metal known as a nail inserted into a water pipe. Traditional methods require the titanium nail to be heated with a butane torch in order to bring the nail to ambient temperatures to vaporize the essential oils for inhalation.

Electrical resistance can be used to alleviate the usage of combustible gasses for the method of heating. With traditional methods the possibility of inhalation of the butane or other combustible gasses can provide the user with adverse health effects if inhaled. In addition to which, the risk of fire or explosion from combustible gasses is a present danger while using torches containing butane.

### SUMMARY OF INVENTION

This invention allows the user to heat the titanium nail by electrical resistance from the use of a variable pitch resistance coil heater. The coil heater is controlled by both a solid state relay and a closed loop advanced proportional plus integral plus derivative controller.

The coil heater and closed loop advanced proportional plus integral plus derivative controller electronically communicate with each other as desired and communication between the connected devices as desired by the means of a thermocouple. The closed loop advanced proportional plus integral plus derivative controller uses an algorithm to calculate an error value as the difference between a measured process variable and a desired set point.

The closed loop advanced proportional plus integral plus derivative controller sends an output signal sent to the solid state relay to open or close the load circuitry. The electrical load of 120 VAC is then provided to the coil heater to generate heat by electrical resistance.

The coil heater rests on the titanium nail and by the process of thermal conduction heat is transferred from the heater coil to the titanium nail.

### BACKGROUND OF THE INVENTION

Used for the process of heating the essential oils of concentrated medical marijuana for the purpose of inhalation. Recent development of concentrated forms of marijuana has provided a product which is free from products ordinarily found in plant material. The plant material may contain but not limited to lipids, waxes, carbohydrates, and chlorophyll.

The current administration of the medical benefits of the essential oils involves the process of heating a rod made of titanium metal known as a nail inserted into a water pipe. The titanium nail is heated to temperatures in excess of but limited to 150 degrees Celsius. The

Traditional methods require the titanium nail to be heated with a butane torch in order to bring the nail to ambient temperatures in order to vaporize the essential oils for inhalation. With traditional methods inhalation of the butane or other combustible gasses provide the user with adverse health effects if inhaled. In addition to which the risk of fire or explosion from combustible gasses is a present danger while using torches containing butane.

To alleviate the usage of combustible gasses for the method of heating, electrical resistance is utilized as an alternative source of heat.

The invention also allows a desired temperature to be set by the user on the closed loop advanced proportional plus integral plus derivative controller, U.S. Pat. No. 4,908,747, invented by Lane, Matsko, Patella, and Scheib issued Mar. 13, 1990. The desired temperature setting is known as the set-point. A desired set-point temperature is needed so the user can ensure the ambient temperature which is needed for the vaporization of the essential oils.

A push button switch, U.S. Pat. No. 8,350,484, invented by Stanley issued Jan. 8, 2013. Allows the users to turn on the electrical utility enclosure. An illuminated power symbol on the push button switch indicates to the user the electrical utility enclosure is on and being supplied power.

The push button switch then allows power to be supplied to the spiral wound shunt type slow blow fuse, U.S. Pat. No. 4,560,971, invented by Oh, issued Dec. 24, 1985. The slow blow fuse protects the closed loop advanced proportional plus integral plus derivative controller from short circuit or over current by the power supply.

the slow blow fuse then provides power to the step down transformer power supply with short circuit protection, U.S. Pat. No. 5,561,576, invented by Baldwin, issued Oct. 1, 1996. The transformer steps down the power supply of 120 VAC to 24 VAC. The step down transformer also contains a slow blow fuse providing additional short circuit and over current protection to the closed loop advanced proportional plus integral plus derivative controller. It is important to provide as much protection to the controller as possible to prevent any damage that may occur from the power supply.

The closed loop advanced proportional plus integral plus derivative controllers output power controls a high-power solid state relay employing photosensitive current augmenting means for faster turn-on time, U.S. Pat. No. 4,902,901, invented by Pernyeszi, issued Feb. 20, 1990. The solid state relay allows closes or opens the circuitry load of 120 VAC. When the circuitry load is closed the load of 120 VAC is then provided to the variable pitch resistance coil heater.

the variable pitch resistance coil heater; application number: U.S. Ser. No. 13/481,667, invented by Long and Juliano, Filing date: May 25, 2012. The coil heater is coiled in a helical fashion with an open center as to fit onto the titanium rod. The coil heater has an inner diameter opening of 14 millimeters.

the variable pitch resistance coil heater is wired to a 4 pin microphone plug seen in universal adapter kit for mini microphone, U.S. Pat. No. 5,805,985, issued Sep. 8, 1998. Invented by Clegg and Reisinger.

### BRIEF DESCRIPTION OF THE DRAWINGS

FIG. 1 is a front perspective view illustrating the front electrical utility enclosure housing unit.

FIG. 2 is a front perspective view illustrating the rear electrical utility enclosure housing unit.

FIG. 3 is a partial view illustrating the electrical utility enclosure chassis.

FIG. 4 is the top perspective view of the electrical utility enclosure housing unit.

FIG. 5 is the front perspective view of the variable pitch resistance coil heater and 4 pin microphone jack

FIG. 6 is the wiring circuit for the variable pitch resistance coil heater and 4 pin microphone jack.

FIG. 7 is the wiring diagram for the electrical utility box enclosing power supply and thermoregulator for a coil heater.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

A controlled heat source without flame provided by the means of a coil heater through the process of electrical resistance.

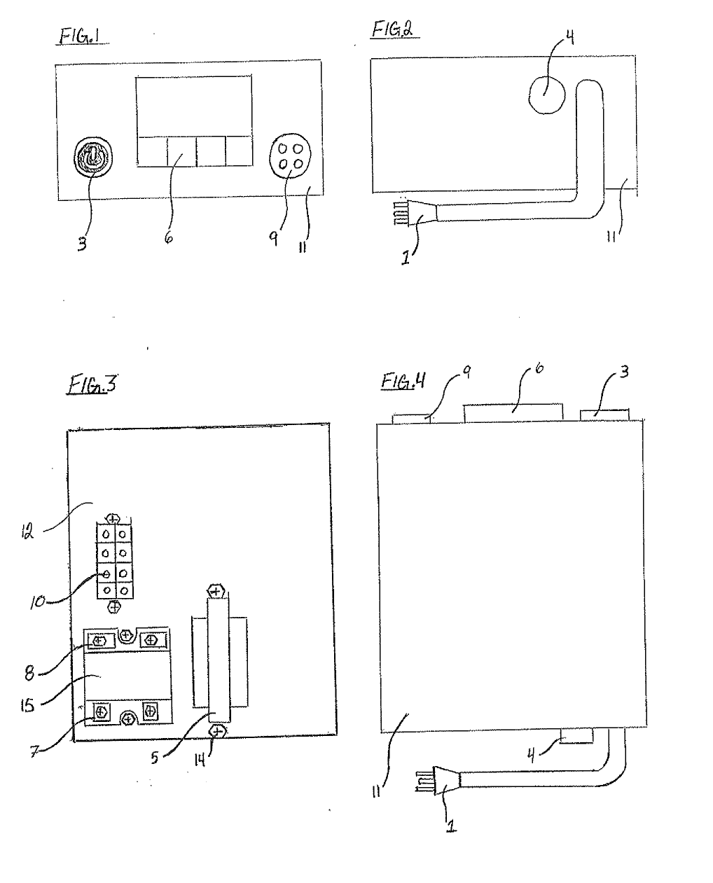

With reference to FIG. 1 and FIG. 2 mounted onto the surface of electrical utility enclosure housing unit (11) will be the advanced proportional plus integral plus derivative controller (6), push button switch; (3), 4-pin citizens band radio plug (9), Spiral wound shunt type slow blow fuse (4) and 120VAC power supply (1)

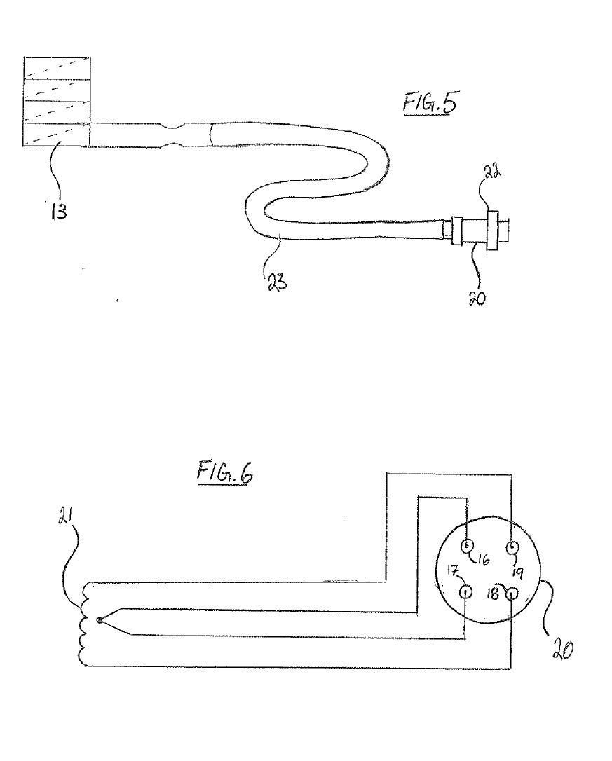

With reference to FIG. 3 mounted to the electrical utility enclosure chassis (12), will be the step down transformer power supply with short circuit protection (5), high-power solid state relay employing photosensitive current augmenting means for faster turn on time (15), terminal block (10). These electrical components will be fastened to the chassis with a chassis mounting screw (14).

With reference to FIG. 7. the power source is a 120 Voltage Alternating Current (VAC) (1) which is grounded to the electrical utility enclosure chassis while supplying electric current to a 120 VAC push button switch (3). In the on position the push button will supply electricity to a 250 VAC spiral wound shunt type slow blow fuse (4). A step-down transformer power supply with short circuit protection will reduce the 120 VAC provided by the slow-blow fuse to 24 VAC (5). It is these two features that protects the Proportional-Integral-Derivative controller form power surge and short circuiting.

With reference to FIG. 7 the power supply of the controller is 24 VAC. The advanced proportional plus integral plus derivative controller (6) allows the user to select a set-point temperature while measuring the value temperature. The temperature is measured by the use of a type k thermocouple. The advanced proportional plus integral plus derivative controller (6) than regulates the temperature to the set point selection. The output power of the controller is between 9 and 32 Volts Direct Current (VDC).

With reference to FIG. 7 when increased temperature is needed the advanced proportional plus integral plus derivative controller (6) output voltage is supplied to the input terminals of the solid-state-relay (7) to open or close circuitry of the load (8). When the load circuitry is closed a 120VAC load then powers the variable pitch resistance coil heater (13).

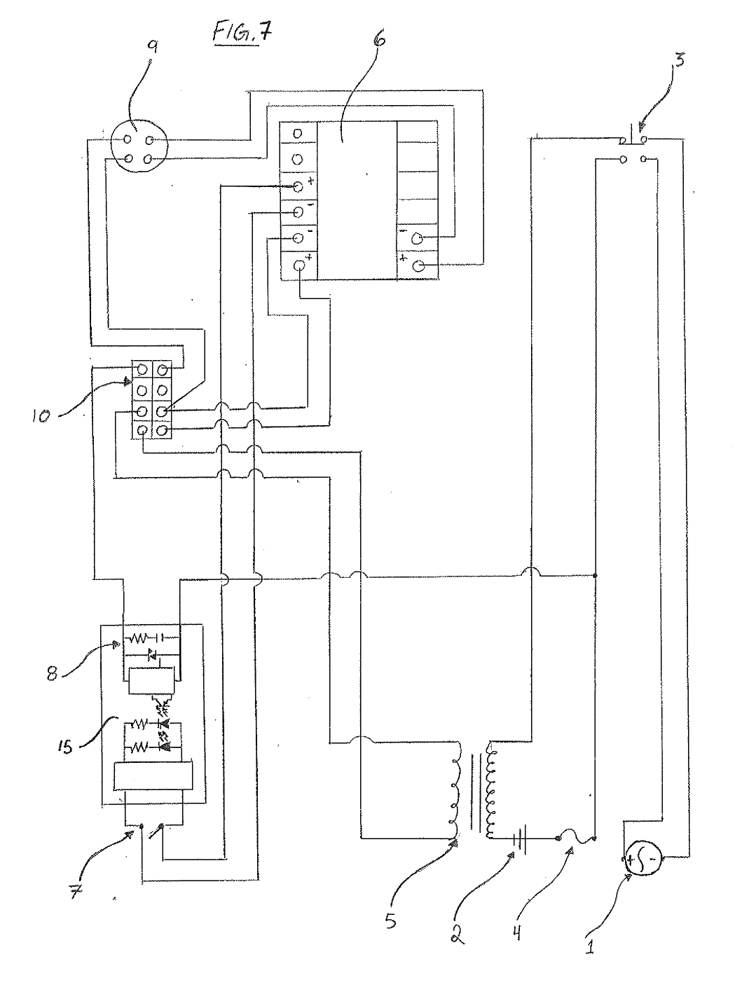

With reference to FIG. 5 the variable pitch resistance coil heater (13) is connected to the 4 pin microphone jack (20). A stainless steel braided cable (23) protects the wires connecting the coil heater and 4 pin microphone jack. A knurled screw on compression ring (22) helps attach to 4 pin microphone plug (9) seen in FIG. 1.

With reference to FIG. 6 is the circuit diagram embodies a type k thermocouple with positive chromel wire (16) and neutral alumel wire (17) connecting to the 4 pin microphone jack (20). The 120 VAC load (19) and neutral wire (18) are also connected to the 4 pin microphone jack (20) and create the resistance (21) within the coil heater.

What is claimed is:

1. An electrical utility box housing: (a) a power switch; (b) a slow-blow fuse; (c) a step down transformer; (d) an closed loop advanced proportional plus integral plus derivative controller; (e) a solid state relay; (f) a terminal block; (g) a 4 pin microphone plug;

2. The electrical utility box of claim 1, wherein said utility is used to provide a controlled electrical current to a variable pitch resistance coil heater containing a thermocouple and being heated through electrical resistance.

3. The electrical utility box of claim 1, wherein the power switch is an illuminated momentary button.

4. The electrical utility box of claim 1, wherein the slow-blow fuse protects components up to 250 VAC.

5. The electrical utility box of claim 1, wherein the step down transformer reduces voltage from 120 VAC to 24 VAC to said advanced proportional plus integral plus derivative controller.

6. The electrical utility box of claim 5, wherein the advanced proportional plus integral plus derivative controller controls the said solid state relay though output of an electrical signal.

7. The electrical utility box of claim 6, wherein the solid state relay opens or closes circuitry to allow the electrical load of 120 VAC to be supplied to the variable pitch resistance coil heater.

8. The electrical utility box of claim 1, wherein the terminal block connects wires to various components.

9. The electrical utility box of claim 1, wherein the 4 pin microphone jack connects to a heater coil in communication to said closed loop advanced proportional plus integral plus derivative controller, and connecting wires supplying electrical current from said solid state relay.

10. The electrical utility box of claim 7, wherein the variable pitch resistance coil heater generates heat by electrical resistance by increased load from said solid state relay, and containing a thermocouple communicating temperature to said closed loop advanced proportional plus integral plus derivative controller.
